(19) United States
(12) Patent Application Publication
(10) Pub. No.: US 2026/0200427 A1
(43) Pub. Date: Jul. 16, 2026

(54) AIR BAG FOR DRIVER'S SEAT

(71) Applicant: AUTOLIV DEVELOPMENT AB, Vargarda (SE)

(72) Inventors: Akira KOIZUMI, Kanagawa (JP); Keitoku MIYAGI, Kanagawa (JP)

(21) Appl. No.: 19/134,084

(22) PCT Filed: Oct. 17, 2023
(86) PCT No.: PCT/JP2023/037574

§ 371 Date: May 29, 2025

(30) Foreign Application Priority Data
Nov. 30, 2022 (JP) 2022-191689

(51) Int. Cl. B60R 21/203; B60R 21/00; B60R 21/2338

(52) U.S. Cl. CPC B60R 21/203; B60R 21/2338; B60R 2021/0009; B60R 2021/23382

(57) ABSTRACT

An airbag cushion including: a steering-side panel positioned on a steering wheel side; an occupant-side panel positioned on an occupant side; and a side panel connecting an edge of the steering-side panel and an edge of the occupant-side panel to form a side part of the airbag cushion. The steering-side panel has a shape to conform to the steering wheel, and the occupant-side panel has an inverted triangular shape having a larger area than the steering-side panel. The airbag cushion in an expanded and deployed state has a cross-sectional area that gradually increases from the steering-side panel toward the occupant-side panel in a cross section orthogonal to an axial direction from the center of the steering-side panel toward the center of the occupant-side panel.

### TECHNICAL FIELD

The present invention is related to a driver's seat airbag for restraining an occupant in the event of an emergency.

### BACKGROUND ART

Currently, essentially all vehicle steering wheels are equipped with a driver's seat airbag. The airbag cushion of the driver's seat airbag is primarily stowed in a central hub of the steering wheel and cleaves a resin cover and the like by the expansion pressure so as to expand and deploy toward the front of an occupant. For example, in the technology of Patent Document 1, an airbag 24 is stowed in a central housing 34 of a steering wheel 38 together with an inflator 32 that supplies gas.

### RELATED ART DOCUMENTS

### Patent Documents

Patent Document 1: U.S. Patent Application Publication No. 2020/0055482

### SUMMARY OF THE INVENTION

### Problem to be Solved by the Invention

It has been found that in the event of an emergency, when an oblique collision occurs, which is a collision occurring at an angle to a traveling direction, an occupant also moves in an oblique direction. In this regard, the airbag 24 of Patent Document 1 is configured to expand in a cone shape from the center of a steering wheel 38, and thus there is a risk that the posture of the occupant may become unstable if the occupant enters at an angle. Furthermore, the airbag 24 of Patent Document 1 has a front panel 102 on the occupant side that is formed in a perfect circle shape, and it is believed that there is a portion that does not contribute to restraining the occupant.

In view of the foregoing, an object of the present invention is to provide a driver's seat airbag capable of reducing the injury value of an occupant by a simple configuration.

### Means for Solving the Problem

In order to solve the aforementioned problem, a representative configuration of a driver's seat airbag according to the present invention is as follows. The driver's seat airbag comprises: an inflator that is stowed in a steering wheel of a vehicle; and an airbag cushion that is stowed in a steering wheel along with the inflator, and expands and deploys to restrain an occupant in a driver's seat. The airbag cushion includes: a steering-side panel that is positioned on the steering wheel side; an occupant-side panel that is positioned on the occupant side; and a side panel that connects an edge of the steering-side panel to an edge of the occupant-side panel to configure a side part of the airbag cushion. Furthermore, the steering-side panel has a shape conforming to the steering wheel; the occupant-side panel has a larger area than the steering-side panel, and has an inverted triangular shape in which an upper part is wider in a vehicle width direction than a lower part; and the expanded and deployed airbag cushion has a cross-sectional area that gradually increases from the steering-side panel toward the occupant-side panel in a cross section orthogonal to an axial direction from the center of the steering-side panel toward the center of the occupant-side panel.

The airbag cushion having the abovementioned configuration has a steering-side panel with a shape conforming to the steering wheel, which efficiently forms a pressure-receiving surface for the steering wheel and makes it possible to maintain the posture of an occupant when restrained.

Furthermore, in general, when the occupant is seated in the driver seat, upper parts of the body, such as the head and the like, are more likely to swing in front-back and left-right directions than the abdomen and the like when the vehicle receives an impact. Therefore, the airbag cushion having the abovementioned configuration has a steering-side panel set in an inverted triangular shape, thereby forming a restraining region that is wider in the vehicle width direction toward the upper part, while reducing the shape of the lower part. Therefore, according to the abovementioned configuration, it is possible to improve the occupant-restraining performance of an airbag cushion while reducing the amount of material used and the gas capacity, thereby contributing to cost reduction. In particular, reducing the gas capacity shortens the time required for the expansion of the airbag cushion to be completed, which leads to the further improvement of the occupant-restraining performance.

The steering-side panel may have a shape that is a projection of a rim or a grip of the steering wheel or a shape similar to the projection shape. With these configurations, the airbag cushion efficiently forms a pressure-receiving surface for the steering wheel, and can efficiently receive a reaction force from the steering wheel.

The steering-side panel may have a securing region that is secured to the steering wheel in a state in which the inflator is inserted therein, and the securing region may be provided on an upper side from the center of the steering-side panel corresponding to the position of a central hub of the steering wheel.

According to the abovementioned configuration, it is possible to efficiently obtain a reaction force from an irregularly shaped steering wheel having a hub provided at an offset position on the upper side.

The airbag cushion may further include one or a plurality of internal tethers having a first end connected to the steering-side panel and a second end connected to the occupant-side panel, inside the airbag cushion, and the internal tether may have a dimension in which the tether tensions when the airbag cushion expands and deploys to pull the occupant-side panel toward the steering-side panel side.

By using the abovementioned internal tether, it is possible to control the shape of the occupant-side panel to, for example, prevent excess expansion of the occupant-side panel or prevent the airbag cushion from swinging and the like, thereby improving the occupant-restraining performance of the airbag cushion, reducing the injury value, and the like.

### Effect of the Invention

With the present invention, a driver's seat airbag capable of reducing the injury value of an occupant by a simple configuration can be provided.

### BRIEF DESCRIPTION OF THE DRAWINGS

FIG. 1 is a diagram depicting an overview of a driver's seat airbag according to an embodiment of the present invention;

FIG. 2 is a perspective view of the airbag cushion of FIG. 1(b) during expansion and deployment;

FIG. 3 is a diagram depicting each panel configuring the airbag cushion of FIG. 2(a);

FIG. 4 is a diagram depicting a process of the airbag cushion of FIG. 1(b) for restraining an occupant in an oblique collision;

FIG. 5 is a diagram depicting an internal structure of the airbag cushion of FIG. 2(a);

FIG. 6 is a modified example of the airbag device 100 of FIG. 1; and FIG. 7 is a view depicting the airbag cushion of FIG. 6(b) from each direction during expansion and deployment.

### DESCRIPTION OF THE PREFERRED EMBODIMENTS

Preferred embodiments according to the present invention will hereinafter be described in detail with reference to the attached drawings. Dimensions, materials, other specific numerical values, and the like indicated in the embodiments are merely examples for ease of understanding of the invention and do not limit the present invention unless otherwise noted. Note that in the present specification and drawings, elements having essentially identical functions and configurations are labeled with identical symbols in order to omit redundant descriptions, and illustrations of elements not directly related to the present invention are omitted.

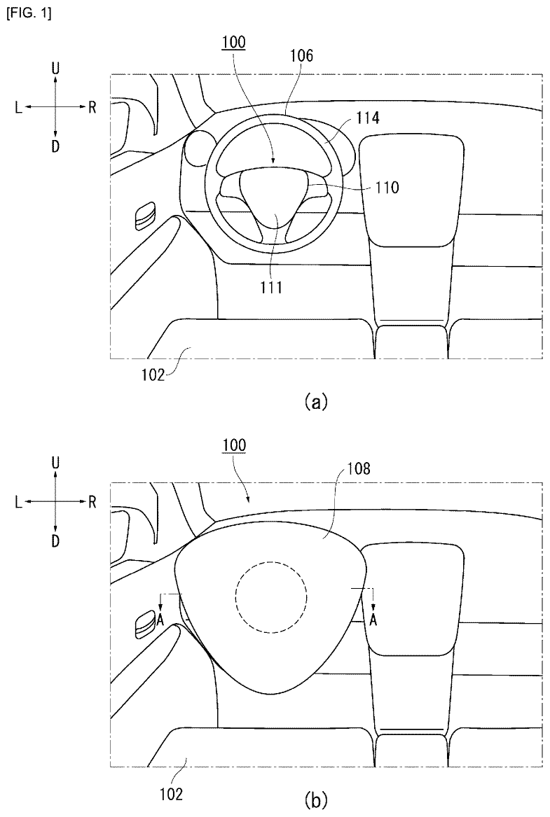

FIG. 1 is a diagram depicting an overview of a driver's seat airbag (hereinafter referred to as airbag device 100) according to an embodiment of the present invention. FIG. 1(a) is a diagram depicting a state of the airbag device 100 before activation. As depicted in FIG. 1(b), the airbag device 100 is implemented as a frontal airbag of a driver's seat 102 on a front row and left side in a left-hand drive vehicle.

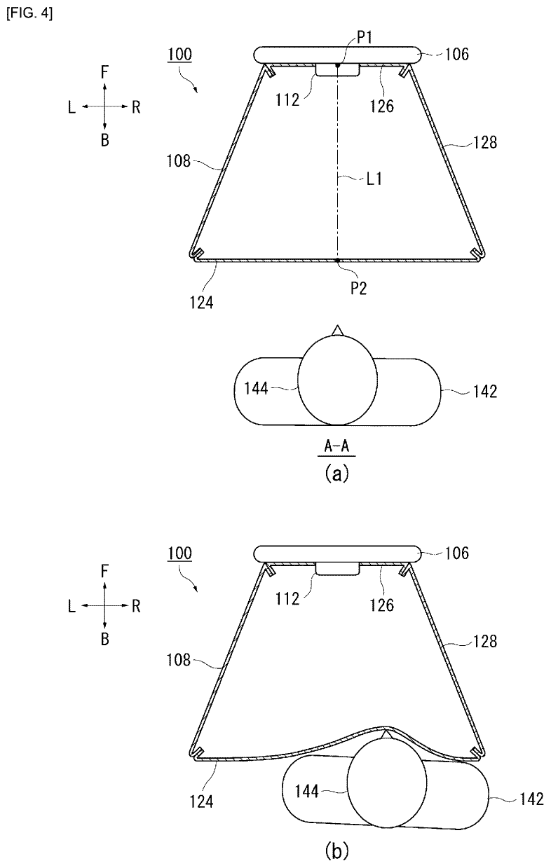

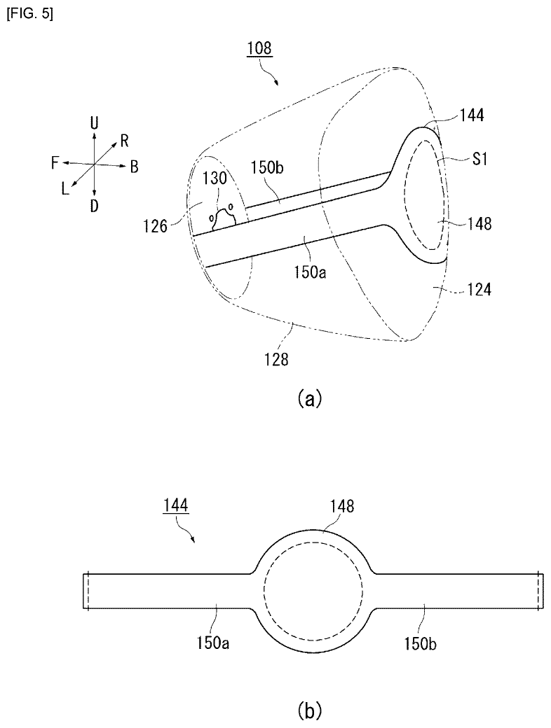

In the present embodiment, when an occupant 142 of the driver's seat (see FIG. 4(a)) is seated in a regular posture in the driver's seat 102, the direction the occupant 142 is facing is referred to as forward, the opposite direction is referred to as backward, and directions indicating the coordinate axis are referred to as the front-back direction. Furthermore, when the occupant 142 is seated in the driver's seat 102 in a regular posture, the right of the occupant 142 is referred to as a right direction, the left of the occupant 142 is referred to as a left direction, and directions indicating the coordinate axis are referred to as the left-right direction. Furthermore, when the occupant 142 is seated in a regular posture, a head direction of the occupant 142 is referred to as upward, a waist direction of the occupant 142 is referred to as downward, and directions indicating the coordinate axis are referred to as the up-down direction.

In the drawings used in the description of embodiments of the present invention below, as necessary, the front, back, left, right, up, and down directions are indicated by arrows F (Forward), B (Back), L (Left), R (Right), U (up), and D (down), with reference to the occupant 142 described above (see to FIG. 4(a)).

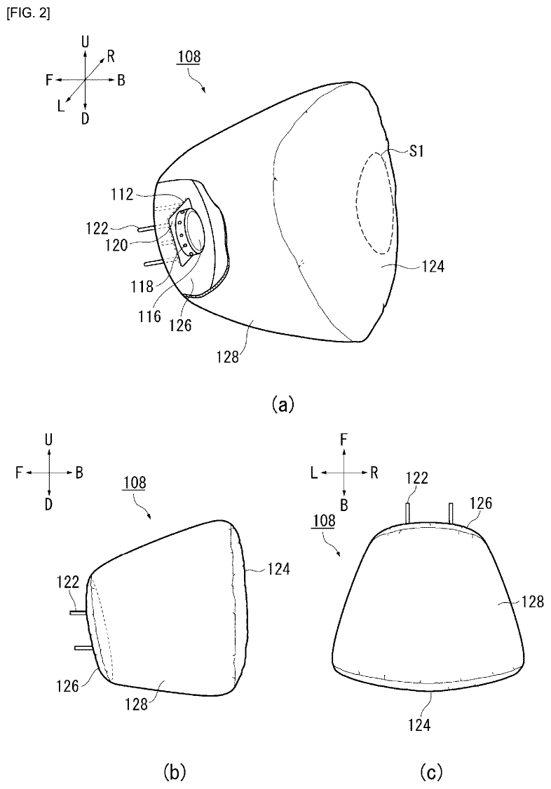

The airbag device 100 of FIG. 1(a) is installed in a steering wheel 106, and the occupant 142 (see FIG. 4(a) and the like) seated in the driver's seat 102 is restrained and protected by an airbag cushion 108 (see FIG. 1(b)) in the event of an emergency, such as an impact to the vehicle, or the like. The airbag cushion 108 is a bag-shaped member that can be expanded using gas, is made compact for stowing by being rolled or folded, and is then stowed together with an inflator 112 (see FIG. 2(a)) in a stowing part 110 in the center of the steering wheel 106.

The stowing part 110 is provided more to the center side than a rim 114 of the steering wheel 106 and the surface thereof is covered with a cover 111. The cover 111 is provided with grooved tear line or the like on the inner side that is designed to cleave when the airbag cushion 108 expands and deploys (see FIG. 1(b)).

FIG. 1(b) is a diagram depicting a state of the airbag device 100 after activation. The airbag cushion 108 expands and deploys in a bag shape towards the occupant 142 (see FIG. 4(a)) in the driver's seat 102, cleaving the cover 111 (see FIG. 1(a)) using expansion pressure of gas from the inflator 112 (see FIG. 2(a)) and restrains the upper body and head of the occupant 142 from moving forward.

The airbag cushion 108 of the present embodiment expands and deploys in an inverted triangular shape as viewed from the driver seat 102 side. The airbag cushion 108 is formed by overlaying and stitching or adhering a plurality of base fabrics forming a surface thereof, or the like.

FIG. 2 is a perspective view of the airbag cushion 108 of FIG. 1(b) during expansion and deployment. FIG. 2(a) is a diagram depicting the airbag cushion 108 of FIG. 1(b) viewed from slightly above the left side of the vehicle in the width direction. In FIG. 2(a), a portion of the panel configuring the airbag cushion 108 is cut out to expose the internal inflator 112.

The airbag cushion 108 is formed from a plurality of panels. For example, the panels that form the airbag cushion 108 include an occupant-side panel 124 positioned on the occupant side, a steering-side panel 126 positioned on the steering wheel 106 side (see FIG. 1(a)), and a side panel 128 that connects the occupant-side panel 124 and the steering-side panel 126 to form a side part of the airbag cushion 108.

The inflator 112 is a gas-generating device secured to a bottom of the stowing part 110 (see FIG. 1(a)). Upon receiving an impact detection signal sent from a sensor (not depicted), the inflator 112 is activated, and thereby supplies gas to the airbag cushion 108. The inflator 112 is disc shaped and includes: a cylindrical main body part 116; a gas discharge hole 118 provided on a side surface of the main body part 116; and a flange 120 provided on an outer circumference of the main body part 116. The side panel 128 or the steering-side panel 126 may be provided with a vent hole (not depicted) or the like for discharging gas to the outside, and the gas from the inflator 112 is discharged to the outside through the vent hole.

The inflator 112 is provided with a plurality of stud bolts 122. The stud bolts 122 pass through the steering-side panel 126 of the airbag cushion 108 and connect to a bottom part of the stowing part 110 of the steering wheel 106 (see FIG. 1(a)). The airbag cushion 108 is also secured inside the stowing part 110 by the stud bolts 122 being fastened.

Examples of currently prevailing inflators include: types which are filled with a gas-generating agent and burn the agent to generate gas; types which are filled with compressed gas and supply gas without generating heat; hybrid types which utilize both combustion gas and compressed gas; and the like. Any of these types can be used for the inflator 112.

FIG. 2(b) is a diagram depicting the airbag cushion 108 of FIG. 2(a) from the left side in the vehicle width direction. The airbag cushion 108 has a larger maximum diameter in the occupant-side panel 124 than in the steering-side panel 126, and expands and deploys in a shape similar to a triangular pyramid as a whole.

FIG. 2(c) is a diagram depicting the airbag cushion 108 of FIG. 2(a) from above. The cushion 108 is in the shape of an essentially symmetrical triangular cone when viewed from above.

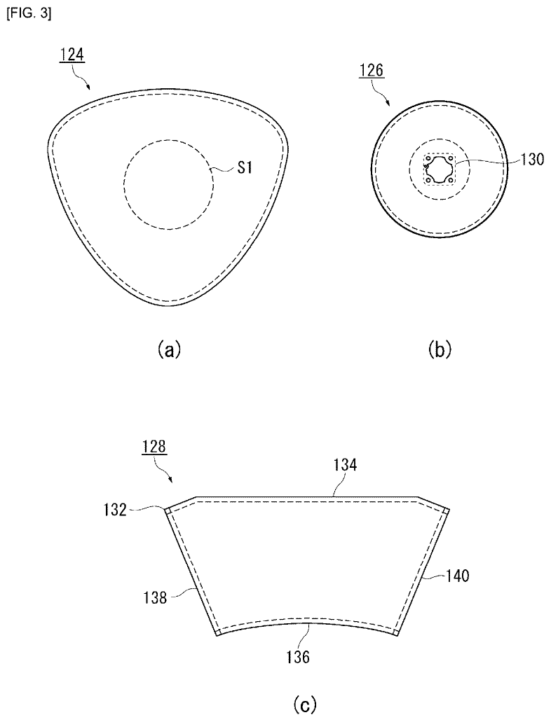

FIG. 3 is a diagram depicting each panel configuring the airbag cushion 108 of FIG. 2(a). In FIG. 3, each panel is depicted in a state spread out on a plane.

FIG. 3(a) is a diagram depicting the occupant-side panel 124 of FIG. 2(a). The occupant-side panel 124 functions as an occupant-restraining surface that restrains the occupant when the airbag cushion 108 is expanded and deployed, and in the present embodiment, in order to protect the head over a wider area than the abdomen, the panel has an inverted triangular shape in which the upper part is wider in the vehicle width direction than the lower part and corner portions are rounded. A stitching S1 with an internal tether 146 (see FIG. 5(a)) to be described later is formed at the center of the occupant-side panel 124.

FIG. 3(b) is a diagram depicting the steering-side panel 126 of FIG. 2(a). The steering-side panel 126 has a shape conforming to the steering wheel (see FIG. 1(a)). In particular, the steering-side panel 126 of the present embodiment has a shape that is a projection of the circular rim 114 of the steering wheel 106 that is gripped by the driver, and is circular in shape along the outer shape of the rim 114. The steering-side panel 126 forms a pressure-receiving surface of the airbag cushion 108 for the steering wheel 106. If the steering-side panel 126 has a shape that conforms to the steering wheel 106, a reaction force can be efficiently received from the steering wheel 106.

Note that the steering-side panel 126 may not have a shape that is exactly the same as the projection of the steering wheel 106, but, for example, may have a shape that is roughly similar to the projection of the steering wheel 106.

A securing region 130 is formed in the center of the steering-side panel 126. The securing region 130 is a region where the inflator 112 (see FIG. 2(a)) is inserted and secured to the stowing part 110 (see FIG. 1(a)).

In the present embodiment, the occupant-side panel 124 of FIG. 3(a) has a larger area than the steering-side panel 126 of FIG. 3(b). Therefore, the expanded and deployed airbag cushion 108 in FIG. 2(c) has a cross-sectional area that gradually increases from the steering-side panel 126 toward the occupant-side panel 124. With these configurations, the airbag cushion 108 is able to efficiently obtain a reaction force from the steering wheel 106 (see FIG. 1(a)) by utilizing the small-diameter steering-side panel 126 that conforms to the shape of the steering wheel 106, while at the same time providing wide and complete protection for the occupant 142 (see FIG. 4(b)) by utilizing the large-diameter occupant-side panel 124.

In the airbag cushion 108, the gas capacity can be reduced by using the small-diameter steering-side panel 126. This reduces the number of panels configuring the airbag cushion 108. Therefore, the airbag cushion 108 can be folded or the like into a smaller stowing form, and thus can be easily installed on a steering wheel 106 (see FIG. 1(a)) with limited stowing space.

Furthermore, the airbag cushion 108 (see FIG. 2(c)) employs the small-diameter steering-side panel 126 and is configured such that the cross-sectional area gradually increases from the steering-side panel 126 toward the occupant-side panel 124, thereby reducing the gas capacity. This configuration eliminates the need for a high-output inflator, and an inflator 112 (see FIG. 2(a)) that is as small and inexpensive as possible can be used. Furthermore, suppressing the gas capacity of the airbag cushion 108 shortens the time required for the expansion of the airbag cushion 108 to be completed, which leads to the improvement of the occupant-restraining performance.

FIG. 3(c) is a diagram depicting the side panel 128 of FIG. 2(a). The side panel 128 can be formed by combining a plurality of sub-panels 132. In the present embodiment, for example, the side panel 128 can be formed by combining three sub-panels 132 in accordance with each side of the inverted triangular-shaped occupant-side panel 124.

For example, the sub-panel 132 in the present embodiment has a shape close to a trapezoid. The sub-panel 132 can be stitched to the outer circumference portion of the occupant-side panel 124 (see FIG. 3(a)) along a long side 134 corresponding to a lower base of the trapezoid, for example, and stitched to an edge of the steering-side panel 126 (see FIG. 3(b)) along an arc 136 corresponding to an upper edge. Furthermore, connecting sides 138, 140 to sides of another sub-panel enable suitably forming a side part of the airbag cushion 108 using the plurality of sub-panels 132.

FIG. 4 is a diagram depicting a process of the airbag cushion 108 of FIG. 1(b) for restraining the occupant 142 in an oblique collision. Each of the diagrams in FIG. 4 correspond to the A-A cross-sectional view of the airbag cushion 108 of FIG. 1(b), depicting the airbag cushion 108 and the occupant 142 as seen from above the vehicle.

FIG. 4(a) is a diagram depicting the appearance of the airbag cushion 108 immediately after expansion and deployment. As depicted in FIG. 4(a), when the vehicle is in an oblique collision, the airbag cushion 108 expands and deploys to the front of the driver's seat 106 in the vehicle (see FIG. 1(b)).

An axis L1 is the center axis of the airbag cushion 108 extending from a center P1 of the steering-side panel 126 toward a center P2 of the occupant-side panel 124. The airbag cushion 108 has a cross-sectional area that gradually increases from the steering-side panel 126 toward the occupant-side panel 124 in a cross section orthogonal to the direction of the axis L1. Therefore, the airbag cushion 108 is able to efficiently obtain a reaction force from the steering wheel 106 by utilizing the small-diameter steering-side panel 126 that conforms to the shape of the steering wheel 106, while at the same time providing wide and complete protection for the occupant 142 by utilizing the large-diameter occupant-side panel 124.

FIG. 4(b) is a diagram depicting the occupant 142 of FIG. 4(a) entering into the airbag cushion 108. The airbag cushion 108 has the occupant-side panel 124 having an inverted triangular shape and is wider in the vehicle width direction toward the upper part, such that the head 144 of the occupant 142 can be restrained even if the occupant 142 moves forward at an angle.

As described above, the airbag cushion 108 is capable of suitably restraining the head 144 of the occupant 142 in both a normal collision and an oblique collision, thereby reducing the injury value of the occupant 142.

The airbag cushion 108 having the abovementioned configuration has a steering-side panel 126 with a shape conforming to the steering wheel 106 (FIG. 1(a)), which efficiently forms a pressure-receiving surface for the steering wheel 106 and makes it possible to maintain the posture of an occupant when restrained.

As described above, when the occupant 142 is seated in the driver seat 102, upper parts of the body, such as the head 144 and the like, are more likely to swing in front-back and left-right directions than the abdomen and the like when the vehicle receives an impact. By setting the steering-side panel 126 of the airbag cushion 108 into an inverted triangular shape, a restraining region is formed that is wider in the vehicle width direction toward the upper part, and the airbag cushion 108 can effectively restrain the head of the occupant 142 in both normal and oblique collisions, thereby reducing the injury value of the occupant 142.

Furthermore, the airbag cushion 108 makes it possible to reduce the amount of material used and the gas capacity by making the occupant-side panel 124 into an inverted triangular shape and reducing the shape of the expanding part, thereby contributing to cost reduction. In particular, reducing the gas capacity shortens the time required for the expansion of the airbag cushion 108 to be completed, which leads to the further improvement of the occupant-restraining performance. As a result, the airbag device 100 can reduce the injury value of the occupant by a simple configuration.

FIG. 5 is a diagram depicting an internal structure of the airbag cushion 108 of FIG. 2(a). FIG. 5(a) depicts the internal structure of the airbag cushion 108 of FIG. 2(a) through each panel.

As depicted in FIG. 5(a), the airbag cushion 108 has the internal tether 146 that is provided between the occupant-side panel 124 and the steering-side panel 126. The internal tether 146 is a member that controls the shape of the occupant-side panel 124 during expansion and deployment of the airbag cushion 108.

FIG. 5(b) is a diagram of the internal tether 146 of FIG. 5(a) spread out on a plane. The internal tether 146 has: a circular center panel 148 having a prescribed area; and tethers 150a, 150b extending from two left and right edges of the center panel 148. The center panel 148 is connected to an inner side of the occupant-side panel 124 by the circular stitching S1.

The tethers 150a, 150b are symmetrically provided on two left and right edges of the center panel 148 and extend toward the steering-side panel 126. End parts of the tethers 150a, 150b can be connected to an edge of the steering-side panel 126, or to the securing region 130 or the like of the steering-side panel 126 around the inflator 112 (see FIG. 2(a)). As a result, a first end of the tethers 150a, 150b is connected to the steering-side panel 126 and a second end is connected to the occupant-side panel 124.

The lengths of the tethers 150a, 150b are set to dimensions in which the tethers are tensioned when the airbag cushion 108 is expanded and deployed, pulling the occupant-side panel 124 toward the steering-side panel 126 via the center panel 148. By using the tethers 150a, 150b, it is possible to change the shape of the occupant-side panel 124 to prevent excess expansion of the occupant-side panel 124 or prevent the airbag cushion 108 from swinging and the like, thereby improving the occupant-restraining performance of the airbag cushion 108, reducing the injury value, and the like. In particular, the tethers 150a, 150b extend from symmetrical points of the center panel 148, and therefore, the shape of the occupant-side panel 124 can be efficiently controlled via the center panel 148.

Note that the center panel 148 may also be connected at an offset position, such as an upper side, lower side, or the like, of the occupant-side panel 124. According to this configuration, the expansion of the upper part and lower part of the occupant-side panel 124 can be appropriately suppressed through the center panel 148. For example, it is possible to suppress the expansion of the lower part 104b of the occupant-side panel 124, allowing for easy entry between the steering wheel 106 and the abdomen of the occupant 142, and the like.

Furthermore, although the tethers 150a, 150b are configured to extend from the left and right sides of the center panel 148, the tethers can also be configured to extend from upper and lower sides, and the number of tethers can be increased. When a plurality of the tethers are provided, the tethers are preferably provided at locations where gas from the inflator 112 (see FIG. 2(a)) does not make direct contact. Furthermore, a single tether may be provided inside the airbag cushion 108 so as to span between the occupant-side panel 124 and the steering-side panel 126.

### Modified Example

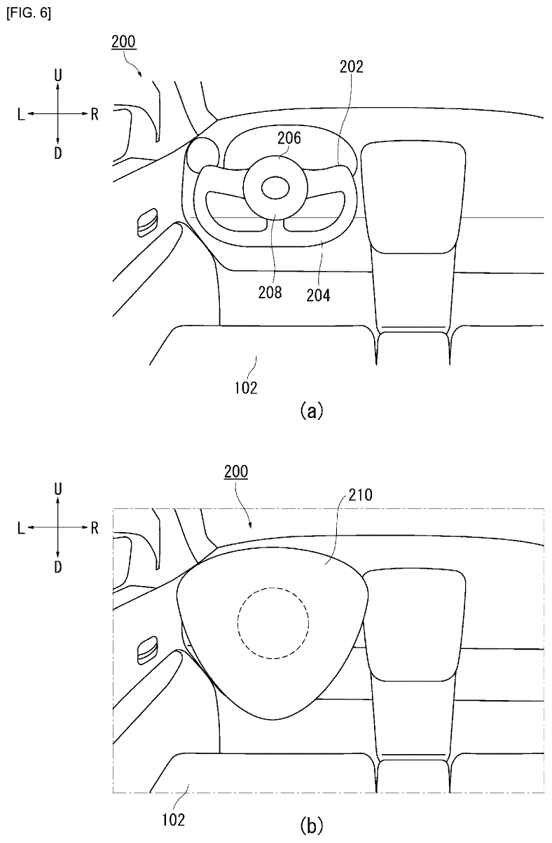

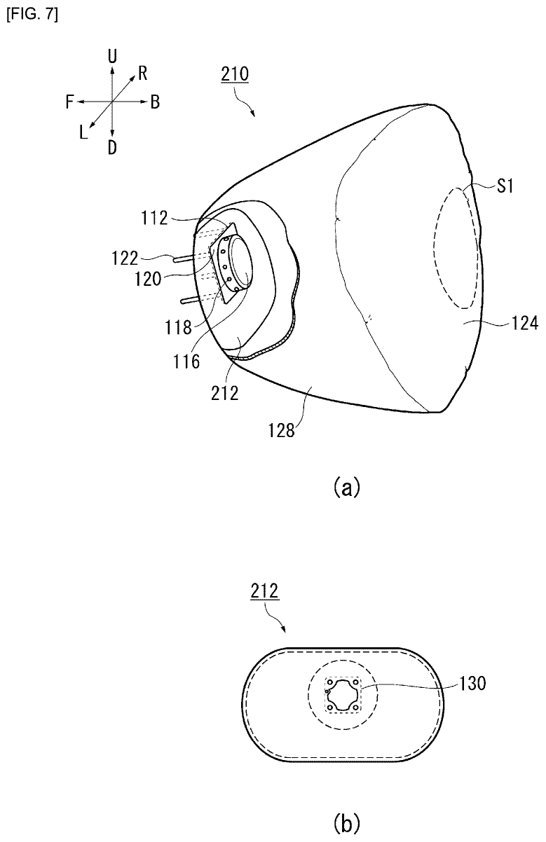

FIG. 6 is a modified example (airbag device 200) of the airbag device 100 of FIG. 1. In the following FIGS. 6 and 7, the same components as those already described are denoted by the same reference numerals, and descriptions thereof will be omitted. Furthermore, the same names as the components described above shall have the same functions unless otherwise indicated even when labeled with a different symbol.

FIG. 6(a) is a diagram depicting a state of the airbag device 200 before activation. A steering wheel 202 (see FIG. 6(b)) in which an airbag cushion 210 is installed in the present embodiment is assumed to be of a configuration in which operation of an occupant is converted into an electrical signal and transmitted to the wheel. The steering wheel 202 has a grip 204 of a shape other than a circle, and has a different shape from the steering wheel 106 having the circular rim 114 of FIG. 1(a).

The grip 204 receives an operation of rotating about a central hub 206, but unlike the conventional circular rim 114 (see FIG. 1(a)), an operation of rotating the grip at a large angle is not necessary. Therefore, there is no need to hold the grip with both left and right hands. Therefore, the grip 204 is shaped to be present only on left, right and lower sides of the hub 206, and no structure is present on an upper side of the hub 206.

An airbag cushion 210 is stowed within the central hub 206 of the steering wheel 202. The hub 206 includes: a housing (not depicted in the drawings) for stowing the airbag cushion 210 and a cover 208; and the like. The inflator 112 (see FIG. 2(a)) is also stowed inside the hub 206 together with the cushion 210.

FIG. 6(b) is a diagram depicting a state of the airbag device 200 of FIG. 6(a) after activation. In this modified example as well, the airbag cushion 210 is expanded and deployed between the steering wheel 202 and the occupant in the driver seat 102.

FIG. 7 is a view depicting the airbag cushion 210 of FIG. 6(b) from each direction during expansion and deployment. FIG. 7(a) is a diagram depicting the airbag cushion 210 corresponding to FIG. 2(a). The airbag cushion 210 is different in configuration from the airbag cushion 108 of FIG. 2(a) in terms of the shape of the steering-side panel 212.

FIG. 7(b) is a diagram depicting the steering-side panel 212 of FIG. 7(a). The steering-side panel 212 has a shape conforming to the steering wheel 202. In particular, the steering-side panel 212 of the present embodiment has a shape that is a projection of the grip 204 of the steering wheel 202 that is gripped by the driver, and is a circular shape extending in the left-right direction along the outer shape of the grip 204. Furthermore, the securing region 130 is provided slightly toward the upper part, corresponding to the position of the hub 206.

The steering-side panel 212 forms a pressure-receiving surface of the airbag cushion 210 for the steering wheel 202. If the steering-side panel 212 has a shape that conforms to the steering wheel 202, a reaction force can be efficiently received from the steering wheel 202.

As described above, in the steering-side panel 212, the securing region 130 is provided on the upper side of the center of the steering-side panel 212 corresponding to the position of the hub 206. This allows the steering-side panel 212 to efficiently receive a reaction force from the irregularly shaped steering wheel 202 in which the hub 206 is provided at an offset position on the upper side.

The steering-side panel 212 also has a smaller area than the occupant-side panel 124 of FIG. 3(a). Therefore, the expanded and deployed airbag cushion 210 of FIG. 7(a) also has a cross-sectional area that gradually increases from the steering-side panel 212 toward the occupant-side panel 124.

As with the airbag cushion 210 depicted in FIG. 4, the airbag cushion 210 of the present modified example is able to efficiently obtain reaction force from the steering wheel 202 by utilizing the small-diameter steering-side panel 212 that conforms to the shape of the steering wheel 202, while at the same time providing wide and complete protection for the occupant 142 (see FIG. 4(b)) by utilizing the large-diameter occupant-side panel 124 in both a normal collision in the front-back direction and an oblique collision.

Note that the steering-side panel 212 may not have a shape that is exactly the same as the projection of the steering wheel 202, but, for example, may have a shape that is roughly similar to the projection of the steering wheel 202.

Preferred examples of the present invention were described above while referring to the attached drawings. However, the embodiments described above are preferred examples of the present invention, and other embodiments can be implemented or performed by various methods. In particular, unless described otherwise in the specification of the present application, the invention is not limited to the shape, size, configurational disposition, and the like of parts depicted in detail in the attached drawings. Furthermore, expressions and terms used in the specification of the present application are used for providing a description, and the invention is not limited thereto, unless specifically described otherwise.

Therefore, a person of ordinary skill in the art could obviously conceive of various changed examples or modified examples within the scope described in the scope of the claims, which is understood to naturally belong to the technical scope of the present invention.

### INDUSTRIAL APPLICABILITY

The present invention can be used as driver's seat airbag for restraining an occupant during an emergency.

### EXPLANATION OF CODES

100: Airbag device, 102: Driver seat, 106: Steering wheel, 108: Airbag cushion, 110: Stowing part, 111: Cover, 112: Inflator, 114: Rim, 116: Main body part, 118: Gas discharge hole, 120: Flange, 122: Stud bolt, 124: Occupant-side panel, 126: Steering-side panel, 128: Side panel, 130: Securing region, 132: Sub-panel, 134: Long side, 136: Edge, 138, 140: Side, 142: Occupant, 144: Head, 146: Internal tether, 148: Center panel, 150a, 150b: Tether, L1: Axis, P1, P2: Center, S1: Stitching, 200: Airbag device, 202: Steering wheel, 204: Grip, 206: Hub, 208: Cover, 210: Airbag cushion, 212: Steering-side panel

1. A driver's seat airbag, comprising: an inflator that is stowed in a steering wheel of a vehicle; and an airbag cushion that is stowed in a steering wheel along with the inflator, and expands and deploys to restrain an occupant in a driver's seat, wherein the airbag cushion includes:
a steering-side panel that is positioned on the steering wheel side;
an occupant-side panel that is positioned on the occupant side; and
a side panel that connects an edge of the steering-side panel to an edge of the occupant-side panel to configure a side part of the airbag cushion,
the steering-side panel has a shape conforming to the steering wheel,
the occupant-side panel has a larger area than the steering-side panel, and has an inverted triangular shape in which an upper part is wider in a vehicle width direction than a lower part, and
the expanded and deployed airbag cushion has a cross-sectional area that gradually increases from the steering-side panel toward the occupant-side panel in a cross section orthogonal to an axial direction from the center of the steering-side panel toward the center of the occupant-side panel.

2. The driver's seat airbag according to claim 1, wherein the steering-side panel has a shape that is a projection of a rim or a grip of the steering wheel or a shape similar to the projection shape.

3. The driver's seat airbag according to claim 1, wherein the steering-side panel has a securing region that is secured to the steering wheel in a state in which the inflator is inserted therein, and
the securing region is provided on an upper side from the center of the steering-side panel corresponding to the position of a central hub of the steering wheel.

4. The driver's seat airbag according to claim 1-672, wherein the airbag cushion further includes one or a plurality of internal tethers having a first end connected to the steering-side panel and a second end connected to the occupant-side panel, inside the airbag cushion, and
the internal tether has a dimension in which the tether tensions when the airbag cushion expands and deploys to pull the occupant-side panel toward the steering-side panel side.

5. The driver's seat airbag according to claim 2, wherein the steering-side panel has a securing region that is secured to the steering wheel in a state in which the inflator is inserted therein, and
the securing region is provided on an upper side from the center of the steering-side panel corresponding to the position of a central hub of the steering wheel.

6. The driver's seat airbag according to claim 2, wherein the airbag cushion further includes one or a plurality of internal tethers having a first end connected to the steering-side panel and a second end connected to the occupant-side panel, inside the airbag cushion, and
the internal tether has a dimension in which the tether tensions when the airbag cushion expands and deploys to pull the occupant-side panel toward the steering-side panel side.
